(19) United States
(12) Patent Application Publication
(10) Pub. No.: US 2019/0179495 A1
(43) Pub. Date: Jun. 13, 2019

(54) SCREEN DISPLAY CONTROLLER, METHOD FOR CONTROLLING SCREEN DISPLAY, AND NON-TRANSITORY COMPUTER-READABLE RECORDING MEDIUM HAVING STORED THEREIN PROGRAM FOR CONTROLLING SCREEN DISPLAY

(71) Applicant: FUJITSU LIMITED, Kawasaki-shi (JP)

(72) Inventors: Kazuyoshi WATANABE, Tagata (JP); Yoshiyuki NAKATA, Kawasaki (JP)

(73) Assignee: FUJITSU LIMITED, Kawasaki-shi (JP)

(21) Appl. No.: 16/190,848

(22) Filed: Nov. 14, 2018

(30) Foreign Application Priority Data
Dec. 12, 2017 (JP) 2017-237988

(51) Int. Cl. G06F 3/0482; G06F 3/0481; G06F 3/0484

(52) U.S. Cl. CPC G06F 3/0482; G06F 3/0484; G06F 3/04817

(57) ABSTRACT

A screen display controller includes a setting processor, a first display processor, and a second display processor. The setting processor sets a filtering condition for a plurality records, the filtering condition narrowing one or more display target records. The first display processor displays, on a display device, the display target records for which the filtering condition is set by the setting processor. The second display processor displays, when a pointer displayed on the screen of the display is located inside a particular area, a content of the filtering condition set by the setting processor on a display device.

### CROSS-REFERENCE TO RELATED APPLICATION

This application is based upon and claims the benefit of priority of the prior Japanese Patent application No. 2017-237988, filed on Dec. 12, 2017, the entire contents of which are incorporated herein by reference.

### FIELD

The embodiment discussed herein is directed to a screen display controller, a method for controlling screen display, and a non-transitory computer-readable recording medium having stored therein a program for controlling screen display.

### BACKGROUND

Since a storage device provides tens of thousands of virtual disks (may also be referred to as “volumes”) according to some system configurations, tens of thousands of rows of the volume information (may also be referred to as “records”) are displayed on a Graphical User Interface (GUI).

To enhance the convenience, it is conceivable that the number of rows of records to be displayed on the GUI is reduced by using a filtering function. Examples of a narrowing condition (may also be referred to as “filtering condition”) by the filtering function are “volume name” and “volume capacity”. After being set, the filtering condition may be stored in a storing device provided to the storage device.

In cases where the filtering function is working, the number of records narrowed after the filtering condition is set, the ON/OFF status of the filtering condition, and the contents of the filtering condition may be displayed on the GUI along with the records, for example.

[Patent Literature 1] Japanese Laid-open Patent Publication No. 2008-282197

[Patent Literature 2] International Publication Pamphlet No. WO 2009/153831

[Patent Literature 3] Japanese Laid-open Patent Publication No. 2012-22594

However, simultaneously displaying the number of records narrowed after the filtering condition is set, the ON/OFF status of the filtering condition, and the contents of the filtering condition on the screen would increase the number of items displayed on the screen and narrow the display area for records. In particular, two or more filtering conditions may be set and would occupy an increased number of displayed items if the contents of the filtering condition is displayed on the screen.

### SUMMARY

According to an aspect, a screen display controller includes: a setting processor that sets a filtering condition for a plurality records, the filtering condition narrowing one or more display target records; a first display processor that displays, on a display device, the display target records for which the filtering condition is set by the setting processor; and a second display processor that displays, when a pointer displayed on the screen of the display is located inside a particular area, a content of the filtering condition set by the setting processor on a display device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating the hardware configuration of a screen display controller according to an example of an embodiment;

FIG. 2 is a block diagram schematically illustrating the functional configuration of a screen display controller of FIG. 1;

FIG. 3 is a diagram illustrating an example of screen display of a record table of a screen display controller of FIG. 1;

FIG. 4 is a diagram illustrating an example of a display setting screen of a screen display controller of FIG. 1;

FIG. 5 is a diagram illustrating an example of a filtering condition storing table used in a screen display controller of FIG. 1;

FIG. 6 is a diagram illustrating an example of screen display of a record table when a filtering condition is set in a screen display controller of FIG. 1;

FIG. 7 is a diagram illustrating an example of first screen display of the contents of a filtering condition in a screen display controller of FIG. 1;

FIG. 8 is a diagram illustrating an example of second screen display of the contents of a filtering condition in a screen display controller of FIG. 1;

FIG. 9 is a flow diagram illustrating an example of a succession of procedural steps of displaying a record table in a screen display controller of FIG. 1;

FIG. 10 is a flow diagram illustrating an example of a succession of procedural steps of setting a filtering condition in a screen display controller of FIG. 1;

FIG. 11 is a flow diagram illustrating an example of a succession of procedural steps of displaying the contents of a filtering condition in a screen display controller of FIG. 1; and

FIG. 12 is a diagram illustrating an example of screen display of the contents of a filtering condition in a screen display controller according to a modification to the embodiment.

### DESCRIPTION OF EMBODIMENT(S)

Hereinafter, description will now be made in relation to an embodiment with reference to the accompanying drawings. The following embodiment is exemplary, and does not have intention to exclude various modifications and applications of techniques not mentioned in the embodiment. In other words, various changes and modifications can be suggested without departing from the scope of the embodiment.

The drawings do not illustrate therein all the functions and elements included in the embodiment, and may include additional functions and elements to those illustrated in the accompanying drawings.

Throughout the drawings, like reference numbers designate the same or substantially the same parts and elements, so repetitious description is omitted here.

### (A) EXAMPLE OF EMBODIMENT

### (A-1) Example of a System Configuration

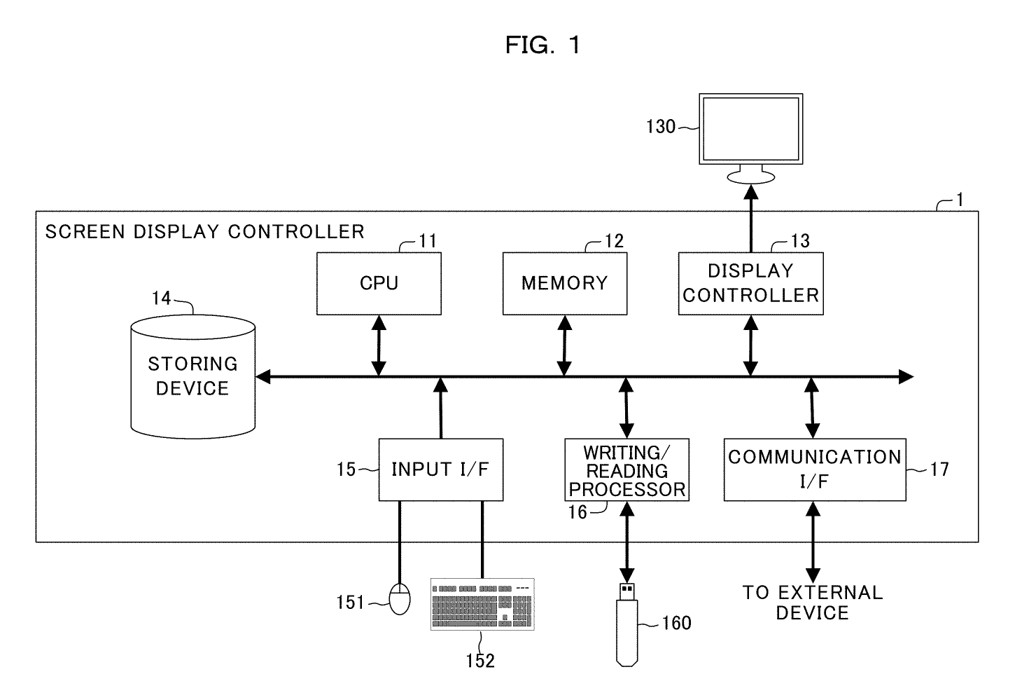

FIG. 1 is a block diagram schematically illustrating the hardware configuration of a screen display controller 1 according to an example of the present embodiment.

The screen display controller 1 includes a Central Processing Unit (CPU) 11, a memory 12, a display controller 13, a storing device 14, an input interface (I/F) 15, a writing/reading processor 16, and a communication I/F 17.

The memory 12 is exemplarily a storing device including a Read Only Memory (ROM) and a Random Access Memory (RAM). Into the ROM of the memory 12, a program such as a Basic Input/Output System (BIOS) may be written. A software program in the memory 12 may be appropriately read into and executed by the CPU 11. The RAM of the memory 12 may be used as a primary recording memory or a working memory.

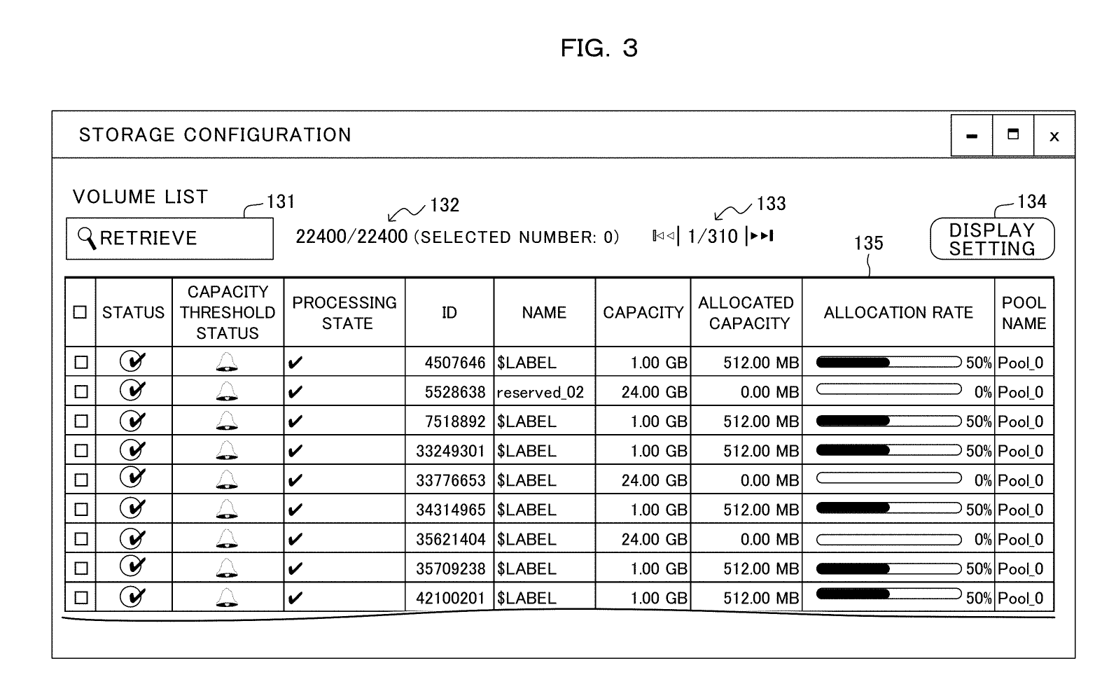

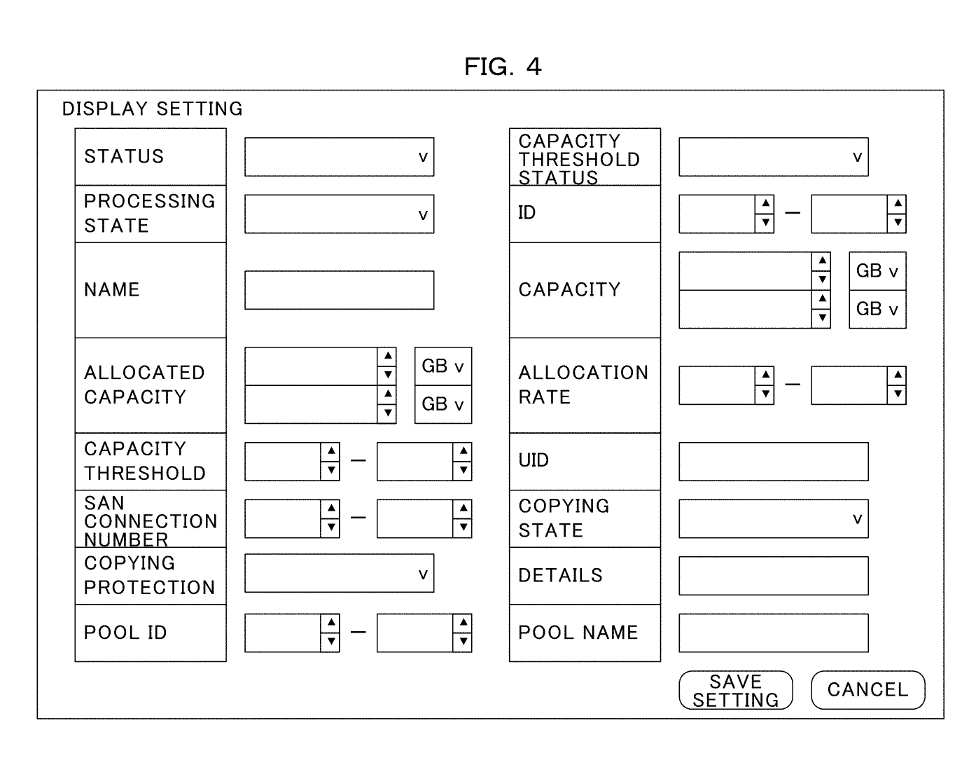

The display controller 13 is connected to a monitor 130 (display device) and controls the monitor 130. Examples of the monitor 130 are an LCD, an Organic Light-Emitting Diode (OLED) display, a Cathode Ray Tube (CRT) display, and an electronic paper display. The monitor 130 displays thereon various types of information to, for example, the operator. The monitor 130 may be combined with an input device and may be exemplified by a touch panel. The monitor 130 displays thereon a record table screen (to be described below with reference to FIG. 3) and a display setting screen (to be described below with reference to FIG. 4).

The storing device 14 is a device that readably and writably stores data and may be exemplified by a Hard Disk Drive (HDD), a Solid State Drive (SSD), and a Storage Class Memory (SCM).

The input I/F 15 is connected to an input device such as a mouse 151 and a keyboard 152, and controls the input device such as the mouse 151 and the keyboard 152. The mouse 151 and the keyboard 152 are examples of an input device through which the operator makes various inputs.

The writing/reading processor 16 is configured to be able to mount a recording medium 160 thereon. The writing/reading processor 16 is configured to be capable of reading information recorded in the recording medium 16 under a state where the recording medium 160 is mounted on the writing/reading processor 16. In this example, the recording medium 160 is portable. Examples of the recording medium 160 are a flexible disk, an optical disk, a magnetic disk, and a magneto-optical disk, and a semiconductor memory.

The communication I/F 17 is an interface that makes the screen display controller 1 possible to communicate with an external device.

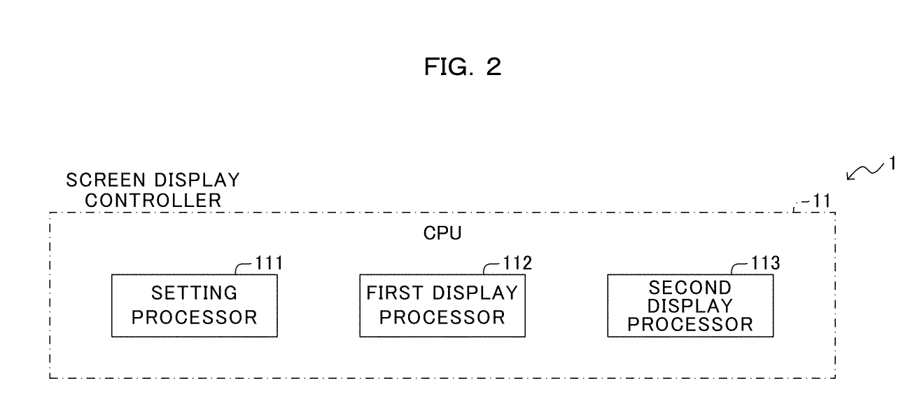

FIG. 2 is a block diagram schematically illustrating the functional configuration of the screen display controller 1 of FIG. 1.

The CPU 11 is a processor that carries out various controls and calculations, and achieves various functions by executing the Operating System (OS) and programs stored in the memory 12. Specifically, as illustrated in FIG. 2, the CPU 11 of the server device 1 functions as a setting processor 111, a first display processor 112, and a second display processor 113.

The program to achieve the functions as the setting processor 111, the first display processor 112, and the second display processor 113 is provided, for example, in the form of being recorded in the above-described recording medium 160. The computer reads the program from the recording medium 160 through the writing/reading processor 16, and transfers the read program to an internal or external storing device to store therein for future use. Otherwise, the program may be recorded in a storing device (recording medium) such as a magnetic disk, an optical disk, or a magneto-optical disk, and be provided from the storing device to the computer through a communication path.

In achieving the functions of the setting processor 111, the first display processor 112, and the second display processor 113, the program stored in the internal storing device (in this embodiment, the memory 12) is executed by the microprocessor (CPU 11 of the present embodiment) of the computer. Alternatively, the computer may read and execute the program recorded in the recording medium 160.

The CPU 11 exemplarily controls the operation of the overall screen display controller 1. The device to control the operation of the overall screen display controller 1 is not limited to the CPU 11, and may alternatively be one of a Micro Processing Unit (MPU), a Digital Signal Processor (DSP), an Application Specific Integrated Circuit (ASIC), a Programmable Logic Device (PLD), and a Field Programmable Gate Array (FPGA). Further alternatively, the device to control the operation of the overall screen display controller 1 may be a combination including two or more of a CPU, an MPU, a DSP, an ASIC, a PLD, and an FPGA.

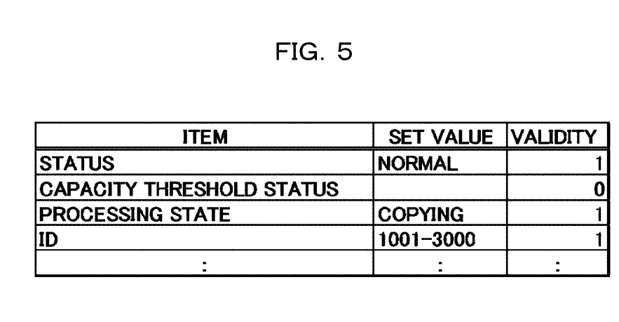

The setting processor 111 sets a filtering condition on a record table 135 (to be described below with reference to FIG. 3, for example) displayed on the monitor 130. The detailed function of the setting processor 111 will be described below with reference to, for example, FIGS. 4 and 5.

The first display processor 112 displays, for example, a record table 135 (to be described below with reference to FIG. 3) on the monitor 130. The detailed function of the first display processor 112 will be described below with reference to, for example, FIGS. 3 and 6-8.

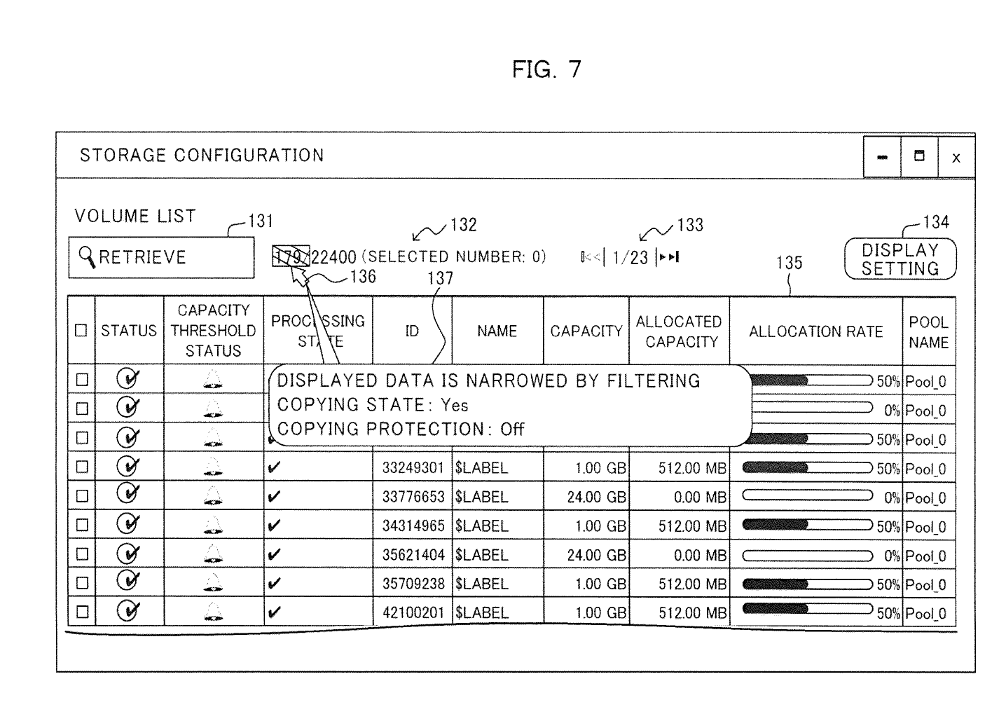

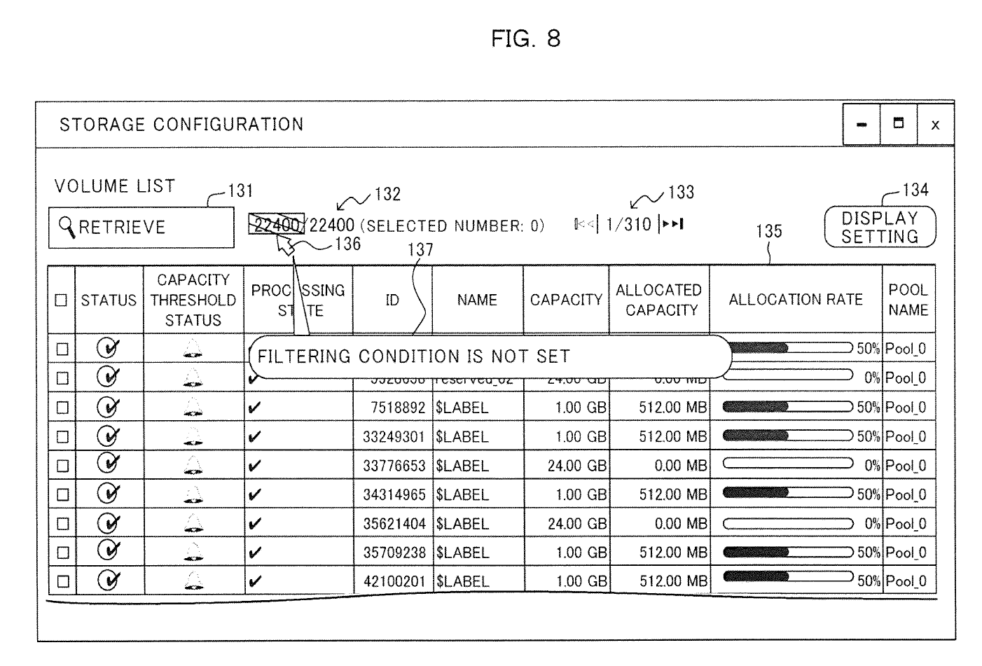

The second display processor 113 displays, for example, the contents of a filtering condition on the monitor 130. The detailed function of the second display processor 113 will be described below with reference to, for example, FIGS. 7 and 8.

FIG. 3 is a diagram illustrating an example of screen display of the record table 135 of the screen display controller 1 of FIG. 1.

The first display processor 112 exemplarily displays a retrieval box 131, a record number 132, a page number 133, a display setting button 134, and a record table 135 on the monitor 130. The first display processor 112 displays, when the display screen is switched to a volume list, when the display screen is updated, or when the filtering condition is set, one or more records satisfying the filtering condition in the form of the record table 135 on the monitor 130 by referring to a filtering condition storing table. The filtering condition storing table will be described below with reference to, for example, FIG. 5. A record may also be referred to as an item.

The retrieval box 131 is used to retrieve an arbitrary record from the record table 135.

The record number 132 indicates the number of records narrowed by the filtering condition (represented by the numerator in FIG. 3) and the number of overall records included in the record table 135 (represented by the denominator in FIG. 3). In the example of FIG. 3, 22400 records out of the overall 22400 records are being displayed. This means that the filtering condition is not set in the example of FIG. 3. The number of records narrowed by the filtering condition and the number of overall records included in the record table 135 may also be referred to as the display target number and the overall record number, respectively.

The page number 133 indicates the number of the page of the record table 135 which page is being displayed on the monitor 130 (represented by the numerator in FIG. 3) and the number of overall pages the record table 135 that can be displayed (represented by the denominator in FIG. 3). In the example of FIG. 3, the first page out of the overall 310 pages is being displayed.

The display setting button 134 is a button to display a display setting screen on the monitor 130. When the display setting button 134 is selected, the display setting screen that is to be detailed below with reference to FIG. 4 is displayed.

The record table 135 includes multiple records. In the example of FIG. 3, the record table 135 is a volume list indicative of the volumes included in the storage device (not illustrated). The record table 135 may also be referred to as a displayed item storing table 135 or simply a table 135.

FIG. 4 is a diagram illustrating an example of a display setting screen of the screen display controller 1 of FIG. 1.

The setting processor 111 sets a filtering condition that the user inputs on the display setting screen to narrow the display targets on the records of the record table 135. As illustrated in FIG. 4, examples of the filtering item are “STATUS”, “CAPACITY THRESHOLD STATUS”, “PROCESSING STATE”, AND “ID”.

FIG. 5 is a diagram illustrating an example of the filtering condition storing table used in the screen display controller 1 of FIG. 1.

The setting processor 111 stores the filtering condition set for the records into, for example, the storing device 14. The filtering condition set for the records are represented by, for example, the filtering condition storing table illustrated in FIG. 5. In other words, the setting processor 111 generates the filtering condition storing table.

As illustrated in FIG. 5, the filtering condition storing table has columns of “ITEM”, “SET VALUE”, AND “VALIDITY”. The “ITEM” column indicates each filtering items illustrated in FIG. 4. The “SET VALUE” column indicates a value set for each filtering item. The “VALIDITY” column indicates whether each filtering item is valid or invalid. For example, a filter item of which the “VALIDITY” column is set to “1” is valid, but a filter item of which the “VALIDITY” column is set to “0” is invalid.

In the example of FIG. 5, a filtering condition which has the filter item “STATUS” of “NORMAL”, a filtering condition which has the filter item “PROCESSING STATE” OF “COPYING”, a filtering condition which has the filter item “ID” of “1001-3000” are set to be valid. In contrast, in the example of FIG. 5, the filter item “CAPACITY THRESHOLD STATUS” is set to be invalid.

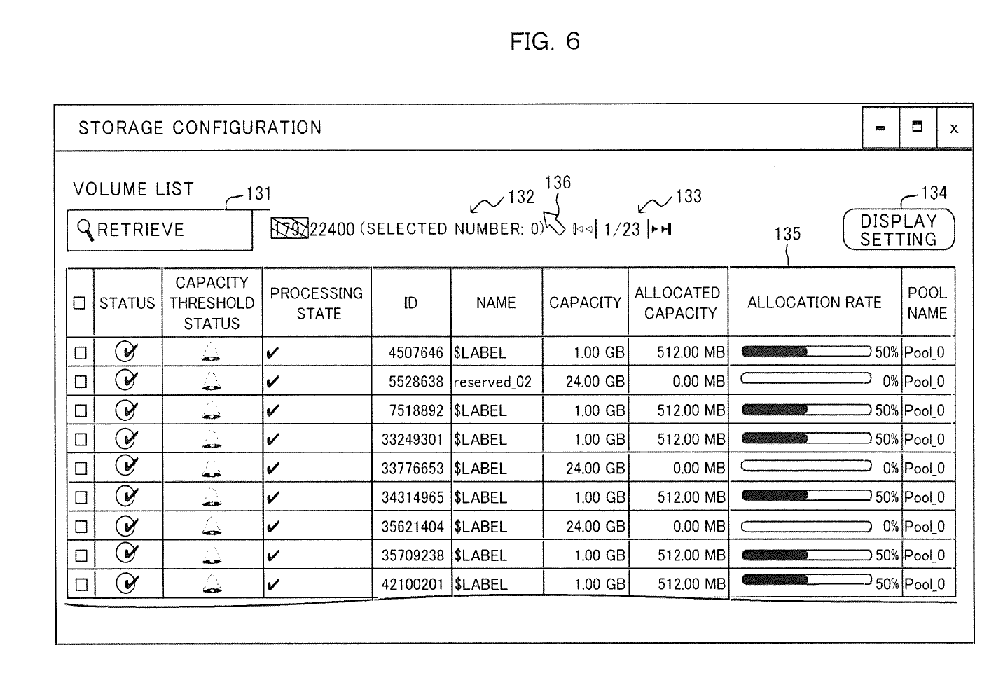

FIG. 6 is a diagram illustrating an example of screen display of the record table 135 when a filtering condition is set in a screen display controller 1 of FIG. 1.

In FIG. 6, a pointer 136 operated by the mouse 151 appears.

The first display processor 112 narrows one or more records to be displayed in the record table 135 on the basis of the filtering condition set by the setting processor 111 by referring to the filtering condition storing table illustrated in FIG. 5, and displays the narrowed records on the monitor 130. In other words, the first display processor 112 displays the display target records satisfying the filtering condition set by the setting processor 111 on the monitor 130.

The first display processor 112 may change the display color of the record number (represented by the numerator in FIG. 6) narrowed by the filtering condition in the record number 132 (hatched in FIG. 6). This allows the user to recognize that the filtering condition is set on the record table 135. In the example of FIG. 6, 179 records out of the overall 22400 records are set to the display targets.

FIG. 7 is a diagram illustrating an example of first screen display of the contents of the filtering condition in the screen display controller 1 of FIG. 1.

In the example of FIG. 7, the pointer (may also be referred to as “cursor”) 136 is moved (in other words, mouse over) into the area (hatched in FIG. 7) indicating the number of records narrowed by the filtering condition in the record number 132. The second display processor 113 responsively raises a tooltip 137 (a display area small with respect to the entire screen) indicating that the filtering condition is set and also indicating the contents of the filtering condition on a predetermined position of the monitor 130 with reference to the filtering condition storing table (see FIG. 5) and displays the tooltip 137 on the screen of the monitor 130. In the example of FIG. 7, the second display processor 113 displays, as the contents of the filtering condition, “COPYING STATE” being “YES” and “COPYING PROTECTION” being “OFF” on the monitor 130. The tooltip 137 may also be referred to as pop-up window 137.

This means that, in cases where the pointer 136 displayed on the screen of the monitor 130 is located within a particular area, the second display processor 113 displays the contents of the filtering condition set by the setting processor 111 on the monitor 130. Here, the particular area is an area that displays therein the number of records (i.e., the display target number) narrowed by the filtering condition.

Here, in cases where the pointer 136 moves from the inside of the area on the display target number of the record number 132 to the outside of the same area (which means that the screen is returned from the state of FIG. 7 to the state of FIG. 6), the second display processor 113 hides the tooltip 137 from the monitor 130.

This means that, in cases where the pointer 136 moves from the inside of the particular area to the outside of the particular area, the second display processor 113 hides the contents of the filtering condition set by the setting processor 111 from the monitor 130. In other words, the second display processor 113 temporarily displays the contents of the filtering condition set by the setting processor 111 only when the pointer 136 is located inside the particular area.

FIG. 8 is a diagram illustrating an example of second screen display of the contents of the filtering condition 1 in the screen display controller of FIG. 1.

In the example of FIG. 8, the setting processor 111 does not set the filtering condition. Consequently, the number of records narrowed by the filtering condition (represented by the numerator in FIG. 8) and the number of overall records included in the record table 135 (represented by the denominator in FIG. 8) are both 22400.

In the example of FIG. 8, under a state where no filtering condition is set, the pointer 136 moves into the area (hatched in FIG. 8) indicating the number of records narrowed by the filtering condition in the record number 132. The second display processor 113 responsively raises a tooltip 137 indicating that the filtering condition is not set at a predetermined position on the screen of the monitor 130.

### (A-2) Example of Operation

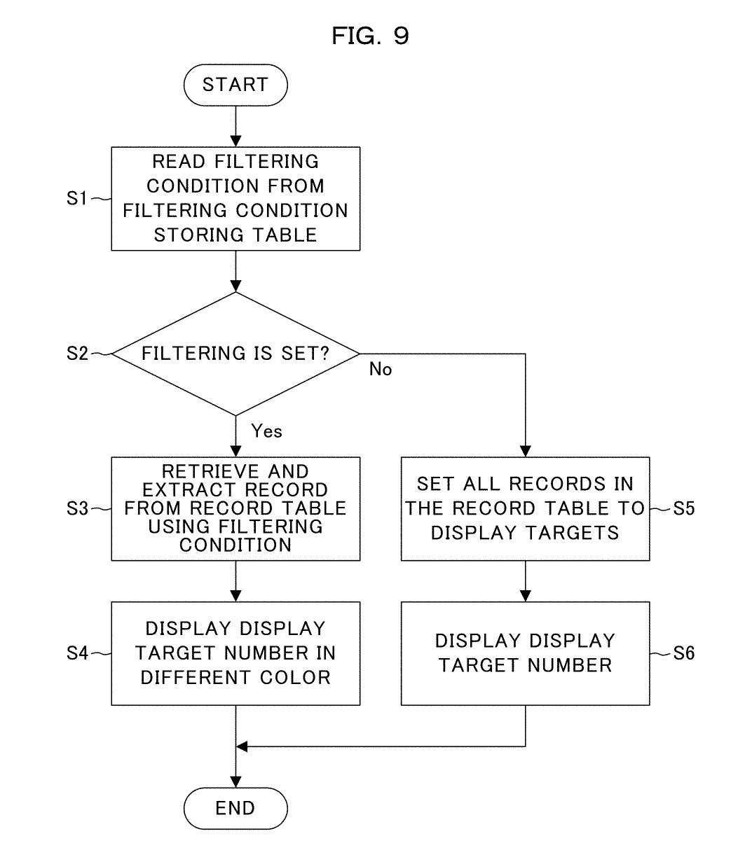

Description will now be made in relation to an example of a succession of procedural steps of displaying the record table 135 in the screen display controller 1 of FIG. 1 with reference to the flow diagram (Steps S1-S6) of FIG. 9.

The first display processor 112 reads the filtering condition being set by the setting processor 111 from the filtering condition storing table (see FIG. 5) (Step S1).

The first display processor 112 determines whether the filtering condition is set in the filtering condition storing table (Step S2).

If the filtering condition is set (see Yes route of Step S2), the first display processor 112 retrieves a record in the record table 135 using the filtering condition and extracts one or more records satisfying the filtering condition (Step S3).

The first display processor 112 displays the display target number of the record number 132 in a different color on the display 130 (Step S4) and ends the process.

If the filtering condition is not set (see No route of Step S2), the first display processor 112 sets all the records in the record table 135 to the display targets (Step S5).

The first display processor 112 displays the display target number in the record number 132 on the monitor 130 (Step S6) and ends the process.

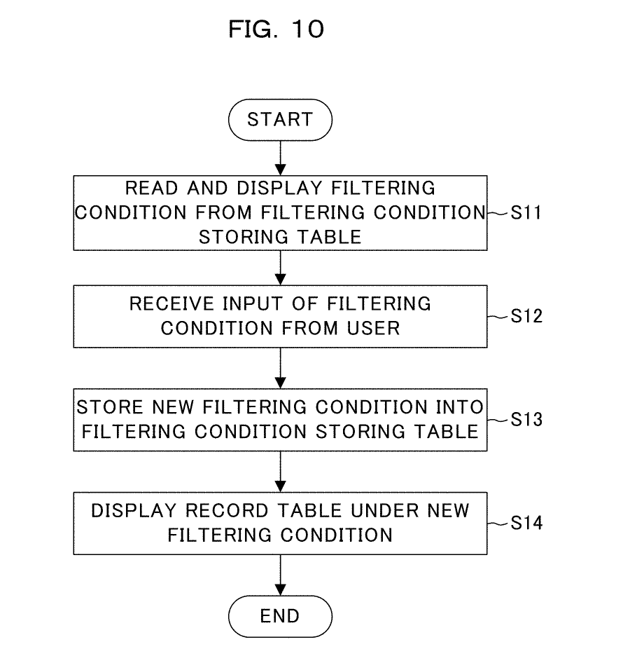

Next, description will now be made in relation to an example of a succession of procedural steps of setting a filtering condition in the screen display controller 1 of FIG. 1 with reference to the flow diagram (Steps S11-S14) of FIG. 10.

The setting processor 111 reads the filtering condition from the filtering condition storing table (see FIG. 5) and displays the read filtering condition on the display setting screen (see FIG. 4) (Step S11).

The setting processor 111 receives an input of a filtering condition from the user on the display setting screen (Step S12).

The setting processor 111 stores the new filtering condition into the filtering condition storing table (Step S13).

The first display processor 112 displays the record table 135 on the monitor 130 under the new filtering condition (Step S14) and ends the process.

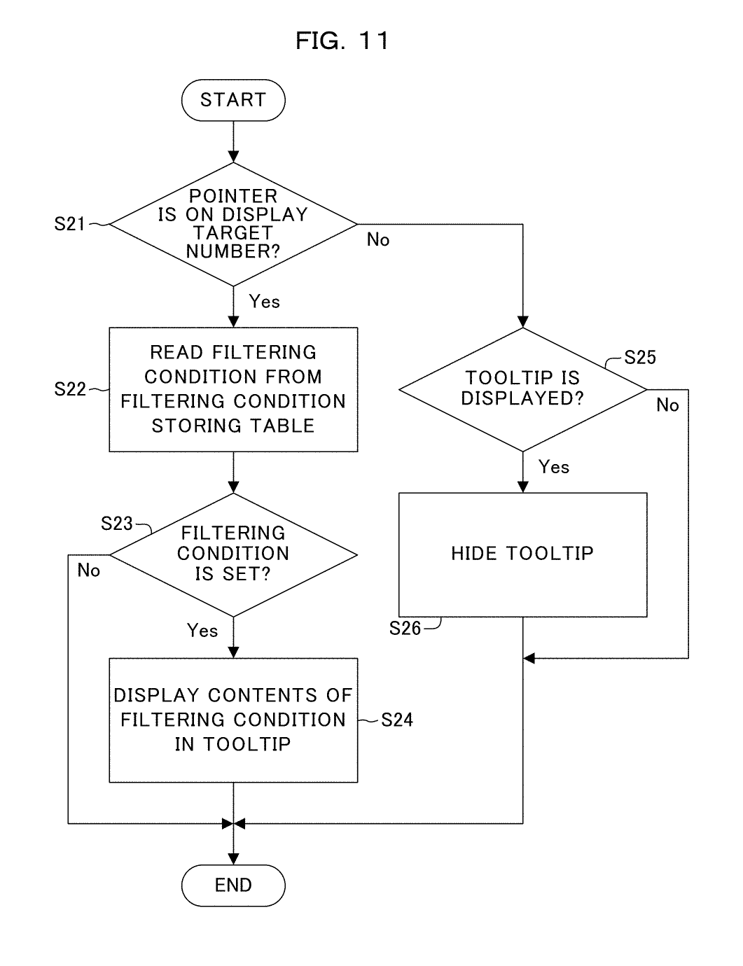

Next, description will now be made in relation to an example of a succession of procedural steps of displaying the contents of a filtering condition in the screen display controller 1 of FIG. 1 with reference to the flow diagram (Steps S21-S26) of FIG. 11.

The second display processor 113 determines, on the basis of the coordinate of the screen, whether the pointer 136 is positioned on the display target number (Step S21).

If the pointer 136 is positioned on the display target number (see Yes route of Step S21), the second display processor 113 reads the filtering condition from the filtering condition storing table (Step S22).

The second display processor 113 determines whether a filtering condition is set in the filtering condition storing table (Step S23).

If the filtering condition is not set (see No route of Step S23), the process ends. Alternatively, if the filtering condition is not set, the second display processor 113 raises the tooltip 137 on the screen to display the indication that the filtering condition is not set.

In contrast, if the filtering condition is set (see Yes route of Step S23), the second display processor 113 raises a tooltip 137 to display the contents of the filtering condition on the monitor 130 (Step S24) and ends the process.

If the pointer 136 is not positioned on the display target number in Step S21 (see No route of Step S21), the second display processor 113 determines whether a tooltip is currently being displayed (Step S25).

If a tooltip 137 is not being displayed (see No route of Step S25), the process ends.

In contrast, if a tooltip 137 is being displayed (see Yes route of Step S25), the second display processor 113 hides the tooltip 137 from the monitor 130 (Step S26) and ends the process.

The determination as to whether the filtering condition is being set in Step S23 may be carried out before Step S21 in which the determination as to whether the pointer 136 is positioned on the display target number is made.

### (A-3) Effects

The screen display controller 1 according to an example of the above embodiment brings the following effects, for example.

The setting processor 111 sets a filtering condition for multiple records to narrow one or more display targets. The first display processor 112 displays the display target records for which the filtering condition is set by the setting processor 111 on the monitor 130. The second display processor 113 displays, when the pointer 136 displayed on the screen of the monitor 130 is located inside a particular area, the contents of the filtering condition set by the setting processor 111 on the monitor 130.

Thereby, the contents of the filtering condition for the records can be efficiently displayed. Specifically, the contents of the filtering condition can be displayed on the same display area of the screen as a display area for a case where the filtering condition is not set.

The second display processor 113 displays the contents of the filtering condition on a part of the display target records.

Consequently, the contents of the filtering condition and the records in the record table 135 are displayed closely to each other, so that the contents of the filtering condition can be efficiently compared with the records in the record table 135.

Only when the pointer 136 is positioned inside the particular area, the second display processor 113 temporarily displays the contents of the filtering condition set by the setting processor 111 on the monitor 130.

This easily switches the contents of the filtering condition between being displayed or being hide.

When the pointer 136 moves from the inside of the particular area to the outside of the particular area, the second display processor 113 hides the contents of the filtering condition set by the setting processor 111 from the monitor 130.

This can hide the contents of the filtering condition when the user does not intend to display the contents of the filtering condition, so that the readability of the record table 135 can be enhanced.

Under a state where setting of the filtering condition by the setting processor 111 is cancelled and also the pointer 136 is positioned inside the particular area, the second display processor 113 displays information indicating that the filtering condition is not set on the monitor 130.

Thereby, the user can clearly recognize that the filtering condition is not set.

The first display processor 112 displays the number of display target records among the multiple records in conjunction with the display target record for which a filtering condition is set by the setting processor 111 on the monitor 130. In cases where the pointer 136 displayed on the screen of the monitor 130 is located inside of an area where the number of narrowed records is displayed, the second display processor 113 displays the contents of the filtering condition set by the setting processor 111 on the monitor 130.

This eliminates the requirement for newly preparing a particular area to display thereon the contents of the filtering condition, so that an amount of data for the screen can be reduced.

### (B) MODIFICATION

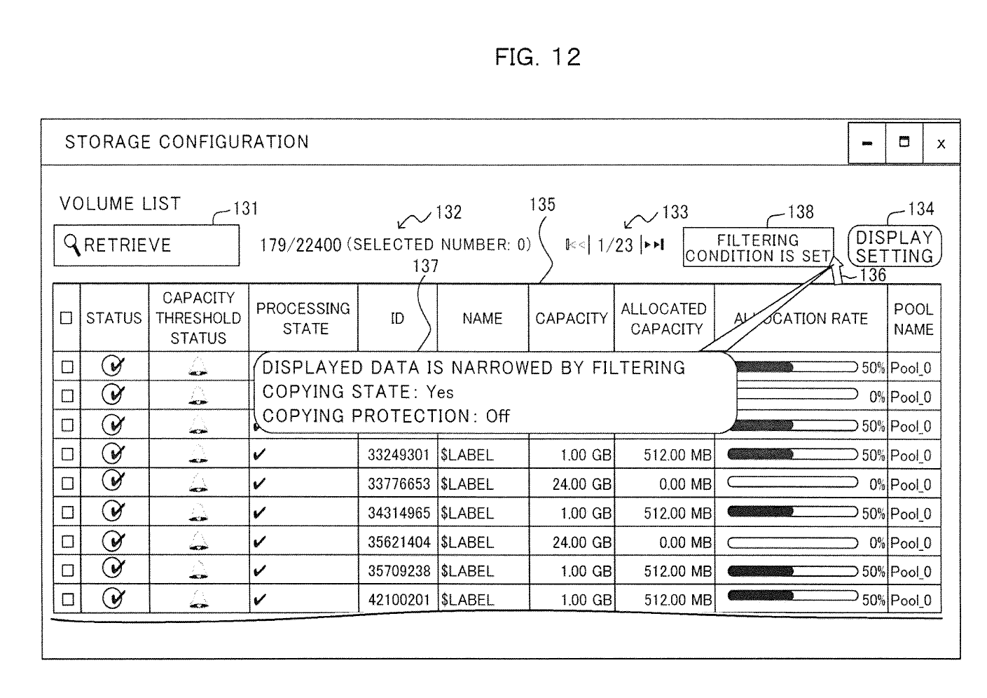

FIG. 12 is a diagram illustrating an example of screen display of the contents of a filtering condition in a screen display controller according to a modification to the embodiment.

In the example of FIG. 12, the first display processor 112 newly displays, in cases where the filtering condition is set by the setting processor 111, an icon 138 on the monitor 130 differently from an example of the above embodiment described with reference to FIG. 7. The icon may also be referred to as an object or a button.

In cases where the pointer 136 is located on (in other words, mouse over) the icon 138, the second display processor 113 displays the tooltip 137 on the monitor 137.

Specifically, the first display processor 112 displays the icon 138 indicating that the filtering condition is being set in conjunction with one or more display target records for which the filtering condition is being set by the setting processor 111 on the monitor 130. In cases where the pointer 136 displayed on the screen of the monitor 130 is located within the area where the icon 138 is displayed, the second display processor 113 displays the contents of the filtering condition set by the setting processor 111 on the monitor 130.

This brings additional effects that the user can easily recognize that the filtering condition is set and that the contents of the filtering condition can be easily displayed to the effects that an example of the above embodiment brings.

### (C) MISCELLANEOUS

The disclosed technique is not limited to the above embodiment and can be variously changed or modified without departing from the scope of the present embodiment. The configurations and processes of the present embodiment can be selected, omitted, or appropriately combined according to the requirement.

In an example of the above embodiment and its modification, the second display processor 113 displays, in the form of the tooltip 137 on the screen, the contents of the filtering condition for the record table 135 containing the records of multiple volumes provided by the storage device. However, the display manner of the contents of the filtering condition is not limited to this. Alternatively, the second display processor 113 may display the contents of the filtering condition for a table containing various records in the form of a tooltip 137 on the screen.

In an example of the above embodiment and its modification, the second display processor 113 displays the contents of the filtering condition in the form of the tooltip 137 in the event of mouse over to the particular area, but the manner of displaying the contents is not limited to this. Alternatively, the second display processor 113 may display the tooltip 137 when the pointer 136 being the state of mouse over to the display target number of the record number 132 or the icon 138 clicks the display target number of the record number 132 or the icon 138.

This can avoid inconvenience that the contents of the filtering condition is displayed on the screen even if the user does not intend to display the contents of the filtering condition.

According to one aspect of the embodiment, the filtering condition for records can be efficiently displayed.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A screen display controller comprising:
a setting processor that sets a filtering condition for a plurality records, the filtering condition narrowing one or more display target records;
a first display processor that displays, on a display device, the display target records for which the filtering condition is set by the setting processor; and
a second display processor that displays, when a pointer displayed on the screen of the display is located inside a particular area, a content of the filtering condition set by the setting processor on a display device.

2. The screen display controller according to claim 1, wherein the second display processor displays the content of the filtering condition on a part of the display target records.

3. The screen display controller according to claim 1, wherein when the pointer moves from an inside of the particular area to an outside of the particular area, the second display processor hides the content of the filtering condition set by the setting processor from the display device.

4. The screen display controller according to claim 1, wherein under a state where the filtering condition set by the setting processor is cancelled and also the pointer is located within the particular area, the second processor displays information indicating that the filtering condition is not set in place of the content of the filtering condition on the display device.

5. The screen display controller according to claim 1, wherein:
the first display processor displays the display target records for which the filtering condition is set by the setting processor and the number of the display target records among the plurality of records on the display device; and
the particular area is an area on which the number of the narrowed records is displayed.

6. The screen display controller according to claim 1, wherein
the first display processor displays, on the display device, the display target records for which the filtering condition is set by the setting processor and an icon indicating that the filtering condition is set; and
the particular area is an area on which the icon is displayed.

7. A method for controlling screen display comprising:
setting a filtering condition for a plurality records, the filtering condition narrowing one or more display target records;
displaying, on a display device, the display target records for which the filtering condition is set; and
displaying, when a pointer displayed on the screen of the display is located inside a particular area, a content of the set filtering condition set on a display device.

8. The method for controlling screen display according to claim 7, further comprising displaying the content of the filtering condition on a part of the display target records.

9. The method for controlling screen display according to claim 7, further comprising, when the pointer moves from an inside of the particular area to an outside of the particular area, hiding the content of the set filtering condition from the display device.

10. The method for controlling screen display according to claim 7, further comprising, under a state where the filtering condition set by the setting processor is cancelled and also the pointer is located within the particular area, displaying information indicating that the filtering condition is not set in place of the content of the filtering condition on the display device.

11. The method for controlling screen display according to claim 7, further comprising displaying the display target records for which the filtering condition is set and the number of the display target records among the plurality of records on the display device, wherein
the particular area is an area on which the number of the narrowed records is displayed.

12. The method for controlling screen display according to claim 7, further comprising displaying, on the display device, the display target records for which the filtering condition and an icon indicating that the filtering condition is set, wherein
the particular area is an area on which the icon is displayed.

13. A non-transitory computer-readable recording medium having stored therein a program for controlling screen display that causes a computer to execute:
setting a filtering condition for a plurality records, the filtering condition narrowing one or more display target records;
displaying, on a display device, the display target records for which the filtering condition is set; and
displaying, when a pointer displayed on the screen of the display is located inside a particular area, a content of the set filtering condition set on a display device.

14. The non-transitory computer-readable recording medium according to claim 13, wherein the program causes the computer to further execute displaying the content of the filtering condition on a part of the display target records.

15. The non-transitory computer-readable recording medium according to claim 13, wherein the program causes the computer to further execute, when the pointer moves from an inside of the particular area to an outside of the particular area, hiding the content of the set filtering condition from the display device.

16. The non-transitory computer-readable recording medium according to claim 13, wherein the program causes the computer to further execute, under a state where the filtering condition set by the setting processor is cancelled and also the pointer is located within the particular area, displaying information indicating that the filtering condition is not set in place of the content of the filtering condition on the display device.

17. The non-transitory computer-readable recording medium according to claim 13, wherein:
the program causes the computer to further execute displaying the display target records for which the filtering condition is set and the number of the display target records among the plurality of records on the display device; and
the particular area is an area on which the number of the narrowed records is displayed.

18. The non-transitory computer-readable recording medium according to claim 13, wherein:
the program causes the computer to further execute displaying, on the display device, the display target records for which the filtering condition and an icon indicating that the filtering condition is set; and
the particular area is an area on which the icon is displayed.
